(19) United States
(12) Patent Application Publication
(10) Pub. No.: US 2022/0374478 A1
(43) Pub. Date: Nov. 24, 2022

(54) INFORMATION PROCESSING DEVICE, INFORMATION PROCESSING METHOD, AND NON-TRANSITORY COMPUTER READABLE STORAGE MEDIUM

(71) Applicant: Yahoo Japan Corporation, Tokyo (JP)

(72) Inventors: Kiyoshi SASAKI, Tokyo (JP); Akira TAJIMA, Tokyo (JP); Takahiro ISHIKAWA, Tokyo (JP); Koji TSUKAMOTO, Tokyo (JP); Seira NAKAMURA, Tokyo (JP); Kazuki NAKAYAMA, Tokyo (JP)

(21) Appl. No.: 17/689,831

(22) Filed: Mar. 8, 2022

(30) Foreign Application Priority Data
May 20, 2021 (JP) 2021-085655

(51) Int. Cl. G06F 16/903

(52) U.S. Cl. CPC G06F 16/90335

(57) ABSTRACT

An information processing device includes: an acquisition unit that collects data on an unspecified large number of users; a generation unit that generates a model for calculating a score of a user group satisfying a predetermined condition by using the data collected; a reception unit that receives designation of a user condition from a business operator on a client side; a calculation unit that calculates a score of a user group satisfying the user condition by using the model; and a providing unit that provides information regarding the score calculated to the business operator.

### CROSS-REFERENCE TO RELATED APPLICATIONS

The present application claims priority to and incorporates by reference the entire contents of Japanese Patent Application No. 2021-085655 filed in Japan on May 20, 2021.

### BACKGROUND OF THE INVENTION

### 1. Field of the Invention

The present invention relates to an information processing device, an information processing method, and an information processing program.

### 2. Description of the Related Art

In a data sharing system, a technology is disclosed in which contents of data owned by each company are safely utilized without being disclosed to other companies. In the technology, while sensitive data provided from an organization or the like participating in a data sharing system is encrypted by a predetermined encryption method (encryption method in which calculation including search, analysis, and the like can be performed in an encrypted state) and subjected to data processing, keys used for encryption and decryption are managed in each organization that has provided the sensitive data.

However, in the above-described related art, it is not considered to disclose contents of data owned by each company to other companies, thus it is not suitable for a case where information collected from users is utilized between companies while personal information is protected. For example, information collected from users by a certain company cannot be complemented using information collected from users by another company.

### SUMMARY OF THE INVENTION

An information processing device includes an acquisition unit that collects data on an unspecified large number of users; a generation unit that generates a model for calculating a score of a user group satisfying a predetermined condition by using the data collected; a reception unit that receives designation of a user condition from a business operator on a client side; a calculation unit that calculates a score of a user group satisfying the user condition by using the model; and a providing unit that provides information regarding the score calculated to the business operator.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an outline of an information processing method according to an embodiment;

FIG. 2 is a diagram illustrating a configuration example of an information processing system according to the embodiment;

FIG. 3 is a diagram illustrating a configuration example of a terminal device according to the embodiment;

FIG. 4 is a diagram illustrating a configuration example of an information providing device according to the embodiment;

FIG. 5 is a diagram illustrating an example of a user information database;

FIG. 6 is a diagram illustrating an example of a history information database;

FIG. 7 is a diagram illustrating an example of a score information database;

FIG. 8 is a flowchart illustrating a processing procedure according to the embodiment; and

FIG. 9 is a diagram illustrating an example of a hardware configuration.

### DETAILED DESCRIPTION OF THE PREFERRED EMBODIMENTS

Hereinafter, modes (hereinafter, described as “embodiments”) for implementing an information processing device, an information processing method, and an information processing program according to the present application will be described in detail with reference to the drawings. Note that the information processing device, the information processing method, and the information processing program according to the present application are not limited by the embodiments. In the following embodiments, the same parts are denoted by the same reference numerals, and redundant description will be omitted.

### 1. Outline of Information Processing Method

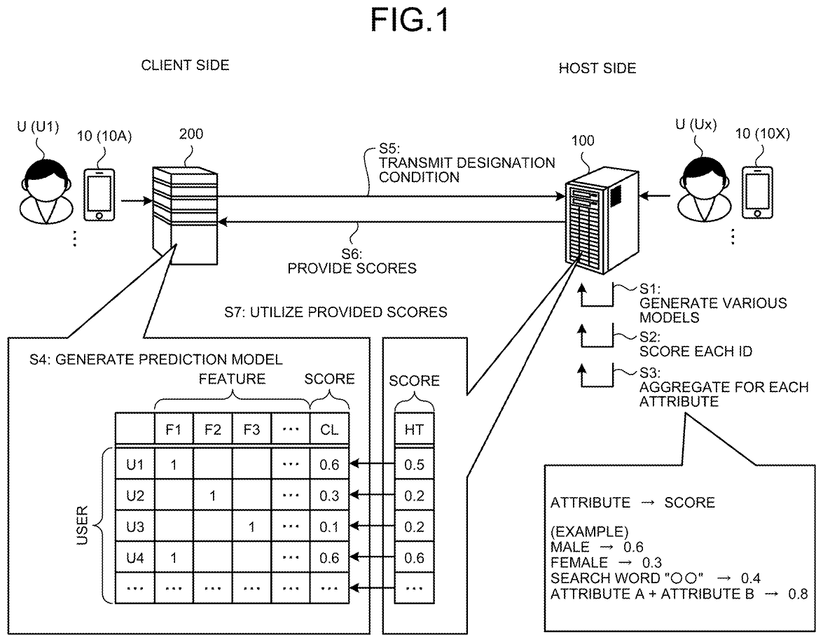

First, an outline of an information processing method performed by an information processing device according to an embodiment will be described with reference to FIG. 1. FIG. 1 is an explanatory diagram illustrating an outline of the information processing method according to the embodiment. Note that, in FIG. 1, a case where information collected from users by a client side company is complemented using information collected from users by a host side company will be described as an example.

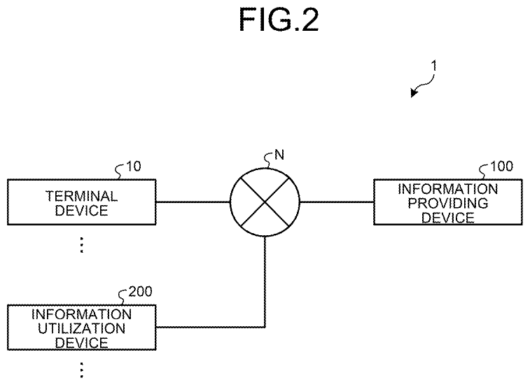

As illustrated in FIG. 1, an information processing system 1 includes a terminal device 10, an information providing device 100, and an information utilization device 200. The terminal device 10, the information providing device 100, and the information utilization device 200 are connected to be communicable with each other in a wired or wireless manner via a network N (see FIG. 2).

The terminal device 10 is a smart device such as a smartphone or a tablet used by a user U, and is a portable terminal device capable of communicating with an arbitrary server device via a wireless communication network such as 4G (Generation) or long term evolution (LTE). Furthermore, the terminal device 10 includes a screen such as a liquid crystal display having a touch panel function, and receives various operations on display data such as contents from the user U, such as a tap operation, a slide operation, and a scroll operation with a finger, a stylus, or the like. Note that an operation performed on a region of the screen where the content is displayed may be an operation on the content. Furthermore, the terminal device 10 may be not only a smart device but also an information processing device such as a desktop personal computer (PC) or a notebook PC.

The information providing device 100 and the information utilization device 200 are information processing devices that provide some kind of Web service online to the terminal device 10 of each user U and acquire information on the user U from the terminal device 10 of each user U, and are implemented by server devices, cloud systems, or the like.

For example, the information providing device 100 and the information utilization device 200 provide, as a Web service, service such as Internet connection, a search service, a social networking service (SNS), e-commerce, electronic payment, an online game, online banking, online trading, lodging/ticket reservation, video/music distribution, news, a map, a route search, route guidance, route information, operation information, and weather forecast. In practice, the information providing device 100 and the information utilization device 200 may mediate the Web service in cooperation with various servers that provide the Web service as described above, or may be in charge of processing the Web service.

Alternatively, the information providing device 100 and the information utilization device 200 cooperate with the terminal device 10 of each user U and provide the terminal device 10 of each user U with an application programming interface (API) service for various applications (hereinafter, an app) and the like and various types of data.

In addition, the information providing device 100 and the information utilization device 200 can acquire user information regarding the user U. For example, the information providing device 100 and the information utilization device 200 acquire information regarding attributes of the user U such as gender, age, and residential area of the user U. Then, the information providing device 100 and the information utilization device 200 store and manage information regarding the attributes of the user U together with identification information (user ID or the like) indicating the user U. Note that the information providing device 100 can acquire detailed user information more than the information utilization device 200.

Further, the information providing device 100 acquires various types of history information (log data) indicating the behavior of the user U from the terminal device 10 of the user U or from various servers or the like on the basis of the user ID or the like. For example, the information providing device 100 acquires a position history which is a history of the position and date and time of the user U from the terminal device 10. In addition, the information providing device 100 acquires a search history which is a history of search queries input by the user U from a search server (search engine). In addition, the information providing device 100 acquires a browsing history which is a history of contents browsed by the user U from a content server. Furthermore, the information providing device 100 acquires a purchase history (payment history) which is a history of product purchase or payment processing of the user U from an e-commerce server or a payment processing server. In addition, the information providing device 100 may acquire a listing history or a sales history which is a history of listing of the user U on a marketplace from an e-commerce server or a payment server. Furthermore, the information providing device 100 acquires a post history which is a history of posts of the user U from a post server or an SNS server that provides a word-of-mouth posting service.

In the present embodiment, the information providing device 100 is a server on the host side, and provides information to the information utilization device 200. In addition, the information utilization device 200 is a server on the client side, receives information from the information providing device 100, and utilizes the information held by itself and the provided information. For example, the information providing device 100 is a server that is operated by a business operator providing a large-scale service (or various services) such as a line connection business operator (provider) or a portal site operating company and has big data on a huge number of users. In addition, the information utilization device 200 is a server that is operated by a client company that provides a predetermined service and has data regarding users of the service.

Both the host side and the client side independently generate (construct) a prediction model regarding user's behavior and demand trend. By complementing the prediction model on the client side with data on the host side, it is expected to improve the accuracy of the prediction model on the client side. In addition, the client side data and the insight can be complemented with the host side data.

The host side can use behavior logs of a plurality of service domains. For example, the host side generates some scoring model (for example, a prediction model for a possibility that a user purchases a refrigerator) using the server data, and scores all users for each user.

Then, the host side receives information regarding user attributes (in addition to attributes, any event having relevance to users, such as a user who has performed “oo” or a user who has input “oo” as a search query) from the client side.

The host side aggregates scores for each user attribute. For example, in a case of a designation “male”, a score given by an automobile purchase model is calculated for the male. At this time, the host side may calculate a score average, top n scores (scores within the top n ranks, etc.), a percentile, and the like. In addition, the host side may calculate a score of a combination of a plurality of attributes.

The host side calculates a list (model) of attribute×score by separately adopting a score average, a top (score upper layer), a distribution of percentiles, a weighted average, and the like so that the score for each attribute changes. At this time, if attribute×score is uniform, an alert (notification) may be issued.

In the present embodiment, a first business operator on the host side generates a model for calculating the certainty (score) that users satisfy a predetermined condition (various kinds of behavior) by using data regarding users who use its own service. In addition, the first business operator receives designation of a user condition (attributes or the like) from a second business operator on the client side, and calculates each score of user groups satisfying the designation condition using the model. Then, the first business operator provides information indicating the relevance between the designation condition and the predetermined condition to the second business operator based on the calculated score.

The designation condition is, for example, a user attribute, user behavior, a user ID common among business operators, or the like. Furthermore, the predetermined condition is, for example, a predetermined behavior (purchase of a predetermined product, use of a predetermined service, participation in a predetermined event, search of a predetermined search query, and the like) or the like performed by users. For example, the predetermined condition may be purchase of an automobile/refrigerator, a search for a “company name,” or the like.

Note that the “user behavior” in the designation condition may be the behavior related to “predetermined behavior performed by users” in the predetermined condition. For example, the “user behavior” may be the behavior (precursor behavior) that is a precursor of the “predetermined behavior performed by users”. In this case, the “predetermined behavior performed by users” indicates the final behavior of users performed after the precursor behavior of the users.

The first business operator may provide the second business operator with relationship information for each predetermined condition from the score for each predetermined condition using the model for each predetermined condition. The relationship information may be a relationship score in which the relationship is expressed by a score (relationship information=relationship score). The first business operator changes the relationship score for each designation condition. In addition, the first business operator may issue an alert according to the score distribution.

### 1-1. Score Providing Method

Here, a score providing method from the host side to the client side according to the embodiment will be described with reference to FIG. 1.

For example, as illustrated in FIG. 1, the information providing device 100 which is a server of the first business operator on the host side collects data regarding users who use its own service, and generates various models using the collected data (step S1).

In the present embodiment, the information providing device 100 has big data regarding an unspecified large number of users, and can generate a highly accurate model. A method of generating a model is arbitrary. For example, the information providing device 100 may generate a statistical prediction model using a machine learning method. Examples of the model include a purchase prediction model of a product (for example, an automobile, a refrigerator, a washing machine, and the like) of a predetermined category, a participation prediction model of a predetermined event, and a predetermined behavior prediction model. Note that the model is not limited to the prediction model, and may be an estimation model, an identification model, or the like.

Subsequently, the information providing device 100 gives scores to all the IDs (step S2). At this time, the information providing device 100 gives a score to the ID (user ID) of each user who uses its own service for each model.

Subsequently, the information providing device 100 aggregates scores for each attribute of the user (step S3). At this time, the information providing device 100 may calculate a total value of scores, an average value of scores, top n scores (top n ranks and the like), percentiles, and the like. Furthermore, the information providing device 100 may calculate a score of a combination of a plurality of attributes.

At this time, the information providing device 100 may construct a model having an attribute of users as input data and a score according to the attribute as output data using a machine learning method by combining the steps of processing from step S1 to step S3. The machine learning method is, for example, deep learning using a deep neural network (DNN). In addition, data mining or other machine learning algorithms may be used.

For example, the information providing device 100 performs machine learning using a recurrent neural network (RNN), a long short-term memory (LSTM), or the like using an attribute of users and a score according to the attribute as a data set, and constructs a score calculation model as a learning model. Then, the information providing device 100 inputs data indicating an attribute of users to the constructed score calculation model, and acquires data indicating a score according to the attribute as an output.

Subsequently, the information utilization device 200, which is a server of the second business operator on the client side, generates an original prediction model using data related to users who use its own service (step S4). The client side prediction model indicates, for each user, an attribute of the user and a score corresponding thereto.

Subsequently, the information utilization device 200 transmits information regarding a designation condition regarding users to the information providing device 100, which is a server of the first business operator on the host side, via the network N (see FIG. 2) (step S5). The designation condition is, for example, an attribute of users or the like. Note that the number of designation condition is not limited to one, and may be plural. That is, a plurality of attributes may be designated at the same time. Furthermore, in a case where an ID of a user is common between the host side and the client side, the ID of the user may be designated as the designation condition.

Subsequently, the information providing device 100 provides the score calculated by itself to the information utilization device 200 according to the designation condition regarding users (step S6). At this time, the information providing device 100 receives designation of an attribute of users from the information utilization device 200, and extracts a score for each attribute calculated by itself according to the designated attribute. Alternatively, when an attribute of users is designated from the information utilization device 200, the information providing device 100 may calculate a score for each attribute according to the designated attribute. Note that when the information providing device 100 receives designation of an ID of a user from the information utilization device 200, the information providing device may extract or calculate a score for each attribute assigned to a user group having the same attribute as the user having the ID.

Note that the score provided from the information providing device 100 to the information utilization device 200 is a score for each attribute assigned to a user group having the same attribute, and is not information associated with a specific individual. That is, the information is irreversible information by which the individual cannot be specified from the score.

Subsequently, the information utilization device 200 utilizes the score provided from the information providing device 100 (step S7). For example, the information utilization device 200 complements the score of the user obtained from its own model by combining the score provided from the information providing device 100. At this time, the information utilization device 200 may add the score provided from the information providing device 100 to the score of the user obtained from its own model as it is or after conversion, or may perform user analysis using each score individually and integrate the analysis results.

Note that, in the above description, a case where the information providing device 100, which is a server of the first business operator on the host side, provides a score to the information utilization device 200, which is a server of the second business operator on the client side, has been described. However, in practice, the information providing device 100 may also receive a score from the information utilization device 200. That is, the information providing device 100 and the information utilization device 200 may exchange scores with each other. At this time, the information providing device 100 may receive scores from a plurality of information utilization devices 200 and complement its own model and data.

Furthermore, the information providing device 100 may also receive a score from another information providing device 100 as one of information utilization devices 200. That is, the information utilization device 200 may also be one of information providing devices 100.

### 2. Configuration Example of Information Processing System

Next, a configuration of the information processing system 1 including the information providing device 100 according to the embodiment will be described with reference to FIG. 2. FIG. 2 is a diagram illustrating a configuration example of the information processing system 1 according to the embodiment. As illustrated in FIG. 2, the information processing system 1 according to the embodiment includes the terminal device 10, the information providing device 100, and the information utilization device 200. These various devices are communicably connected in a wired or wireless manner via the network N. The network N is, for example, a local area network (LAN) or a wide area network (WAN) such as the Internet.

Furthermore, the number of devices included in the information processing system 1 illustrated in FIG. 2 is not limited to the illustrated number. For example, in FIG. 2, for simplification of illustration, one terminal device 10 and one information utilization device 200 are illustrated, but this is merely an example and is not limited thereto, and two or more terminal devices and two or more information utilization devices may be provided.

The terminal device 10 is an information processing device used by the user U. For example, the terminal device 10 is a smart device such as a smartphone or a tablet terminal, a feature phone, a personal computer (PC), a personal digital assistant (PDA), a game machine having a communication function, a car navigation system, a wearable device such as a smart watch or a head mounted display, smart glasses, or the like.

Furthermore, the terminal device 10 can connect to the network N via a wireless communication network such as long term evolution (LTE), fourth generation (4G), or fifth generation (5G), or near field communication such as Bluetooth (registered trademark) or a wireless local area network (LAN), and communicate with the information providing device 100.

The information providing device 100 and the information utilization device 200 are, for example, a PC, a server device, a mainframe, a workstation, or the like. Note that the information providing device 100 and the information utilization device 200 may be implemented by cloud computing.

### 3. Configuration Example of Terminal Device

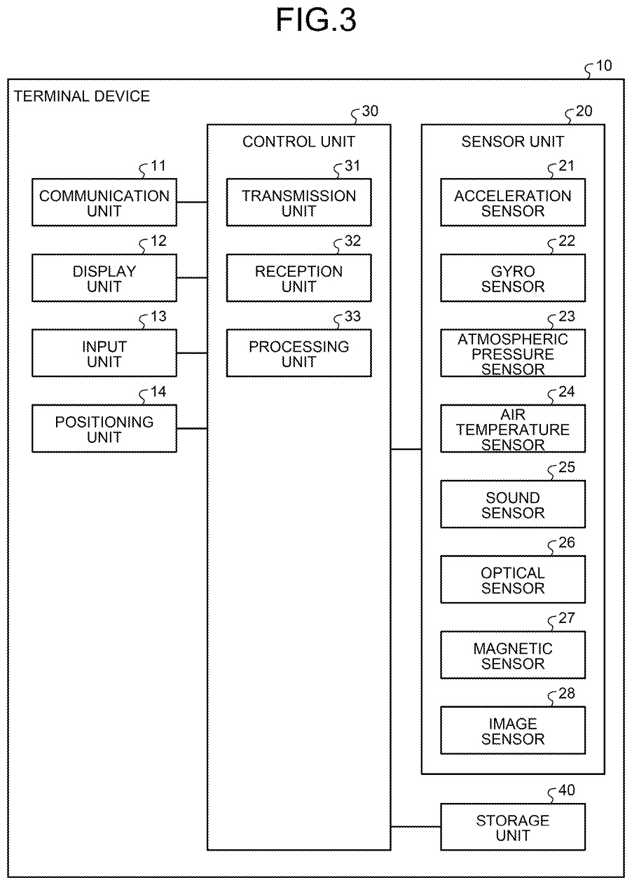

Next, a configuration of the terminal device 10 will be described with reference to FIG. 3. FIG. 3 is a diagram illustrating a configuration example of the terminal device 10. As illustrated in FIG. 3, the terminal device 10 includes a communication unit 11, a display unit 12, an input unit 13, a positioning unit 14, a sensor unit 20, a control unit 30 (controller), and a storage unit 40.

### Communication Unit 11

The communication unit 11 is connected to a network N (see FIG. 2) in a wired or wireless manner, and transmits and receives information to and from the information providing device 100 via the network N. For example, the communication unit 11 is implemented by a network interface card (NIC), an antenna, or the like.

### Display Unit 12

The display unit 12 is a display device that displays various types of information such as position information. For example, the display unit 12 is a liquid crystal display (LCD) or an organic electro-luminescent display (organic EL display). In addition, the display unit 12 is a touch panel type display, but is not limited thereto.

### Input Unit 13

The input unit 13 is an input device that receives various operations from the user U. For example, the input unit 13 includes a button or the like for inputting characters, numbers, and the like. Note that the input unit 13 may be an input/output port (I/O port), a universal serial bus (USB) port, or the like. Furthermore, in a case where the display unit 12 is a touch panel type display, a part of the display unit 12 functions as the input unit 13. Furthermore, the input unit 13 may be a microphone or the like that receives voice input from the user U. The microphone may be wireless.

### Positioning Unit 14

The positioning unit 14 receives a signal (radio wave) transmitted from a satellite of a global positioning system (GPS), and acquires position information (for example, latitude and longitude) indicating the current position of the terminal device 10 which is the own device on the basis of the received signal. That is, the positioning unit 14 measures the position of the terminal device 10. Note that the GPS is merely an example of a global navigation satellite system (GLASS).

Furthermore, the positioning unit 14 can measure the position by various methods other than the GPS. For example, as auxiliary positioning means for position correction and the like, the positioning unit 14 may measure the position using various communication functions of the terminal device 10 as follows.

### Wi-Fi Positioning

For example, the positioning unit 14 measures the position of the terminal device 10 using a Wi-Fi (registered trademark) communication function of the terminal device 10 or a communication network provided by each communication company. Specifically, the positioning unit 14 measures the position of the terminal device 10 by performing Wi-Fi communication or the like and measuring the distance to a nearby base station or access point.

### Beacon Positioning

Furthermore, the positioning unit 14 may measure the position using the Bluetooth (registered trademark) function of the terminal device 10. For example, the positioning unit 14 measures the position of the terminal device 10 by connecting to a beacon transmitter connected by the Bluetooth (registered trademark) function.

### Geomagnetic Positioning

Furthermore, the positioning unit 14 measures the position of the terminal device 10 on the basis of a geomagnetic pattern of a structure measured in advance and a geomagnetic sensor included in the terminal device 10.

### RFID Positioning

Furthermore, for example, in a case where the terminal device 10 has a function of a radio frequency identification (RFID) tag equivalent to a contactless IC card used at a station ticket gate, a store, or the like, or has a function of reading the RFID tag, a used position is recorded together with information on payment or the like made by the terminal device 10. The positioning unit 14 may measure the position of the terminal device 10 by acquiring such information. Furthermore, the position may be measured by an optical sensor, an infrared sensor, or the like included in the terminal device 10.

The positioning unit 14 may measure the position of the terminal device 10 using one or a combination of the above-described positioning means as necessary.

### Sensor Unit 20

The sensor unit 20 includes various sensors mounted on or connected to the terminal device 10. Note that the connection may be a wired connection or a wireless connection. For example, the sensors may be a detection device other than the terminal device 10, such as a wearable device or a wireless device. In the example illustrated in FIG. 3, the sensor unit 20 includes an acceleration sensor 21, a gyro sensor 22, an atmospheric pressure sensor 23, an air temperature sensor 24, a sound sensor 25, an optical sensor 26, a magnetic sensor 27, and an image sensor (camera) 28.

Note that each of the sensors 21 to 28 described above is merely an example and is not limited thereto. That is, the sensor unit 20 may be configured to include a part of each sensor 21 to 28, or may include other sensors such as a humidity sensor in addition to or instead of each sensor 21 to 28.

The acceleration sensor 21 is, for example, a three-axis acceleration sensor, and detects physical movement of the terminal device 10 such as a moving direction, speed, and acceleration of the terminal device 10. The gyro sensor 22 detects physical movement of the terminal device 10 such as inclination in three-axis directions on the basis of angular velocity or the like of the terminal device 10. The atmospheric pressure sensor 23 detects, for example, the atmospheric pressure around the terminal device 10.

Since the terminal device 10 includes the acceleration sensor 21, the gyro sensor 22, the atmospheric pressure sensor 23, and the like described above, the position of the terminal device 10 can be measured using a technique such as pedestrian dead-reckoning (PDR) using each of these sensors 21 to 23 and the like. This makes it possible to acquire indoor position information that is difficult to acquire by a positioning system such as a GPS.

For example, the number of steps, walking speed, and walking distance can be calculated by a pedometer using the acceleration sensor 21. In addition, it is possible to know the traveling direction, the direction of the line of sight, and the inclination of the body of the user U using the gyro sensor 22. In addition, the altitude at which the terminal device 10 of the user U exists and the floor number can be known from the atmospheric pressure detected by the atmospheric pressure sensor 23.

The air temperature sensor 24 detects, for example, an air temperature around the terminal device 10. The sound sensor 25 detects, for example, a sound around the terminal device 10. The optical sensor 26 detects illuminance around the terminal device 10. The magnetic sensor 27 detects, for example, a geomagnetic field around the terminal device 10. The image sensor 28 captures an image around the terminal device 10.

The atmospheric pressure sensor 23, the air temperature sensor 24, the sound sensor 25, the optical sensor 26, and the image sensor 28 described above can detect the atmospheric pressure, the air temperature, the sound, and the illuminance, respectively, and can detect the environment, the situation, and the like around the terminal device 10 by capturing an image of the surroundings. Furthermore, the accuracy of the position information of the terminal device 10 can be improved from the environment, situation, and the like around the terminal device 10.

### Control Unit 30

The control unit 30 includes, for example, a microcomputer including a central processing unit (CPU), a read only memory (ROM), a RAM, an input/output port, and the like, and various circuits. Furthermore, the control unit 30 may include, for example, hardware such as an integrated circuit such as an application specific integrated circuit (ASIC) or a field programmable gate array (FPGA). The control unit 30 includes a transmission unit 31, a reception unit 32, and a processing unit 33.

### Transmission Unit 31

The transmission unit 31 can transmit, for example, various types of information input by the user U using the input unit 13, various types of information detected by each sensor 21 to 28 mounted on or connected to the terminal device 10, position information of the terminal device 10 measured by the positioning unit 14, and the like to the information providing device 100 via the communication unit 11.

### Reception Unit 32

The reception unit 32 can receive various types of information provided from the information providing device 100 and requests for various types of information from the information providing device 100 via the communication unit 11.

### Processing Unit 33

The processing unit 33 controls the entire terminal device 10 including the display unit 12 and the like. For example, the processing unit 33 can output various types of information transmitted by the transmission unit 31 and various types of information from the information providing device 100 received by the reception unit 32 to the display unit 12 to display.

### Storage Unit 40

The storage unit 40 is implemented by, for example, a semiconductor memory element such as a random access memory (RAM) or a flash memory, or a storage device such as a hard disk drive (HDD), a solid state drive (SSD), or an optical disc. The storage unit 40 stores various programs, various types of data, and the like.

### 4. Configuration Example of Information Providing Device

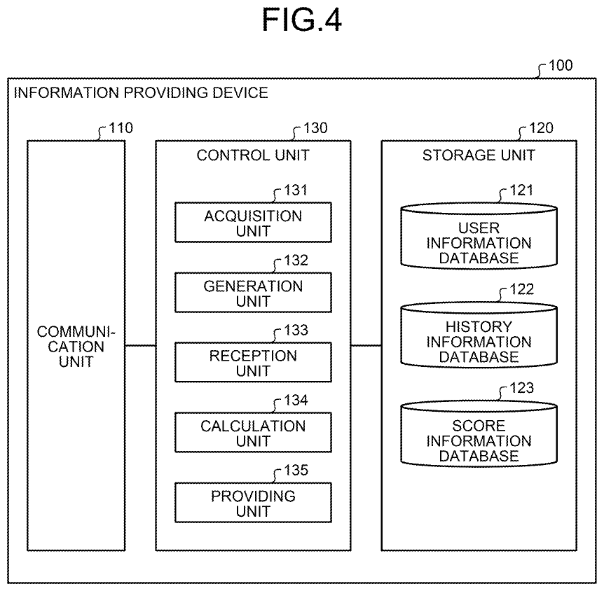

Next, a configuration of the information providing device 100 according to the embodiment will be described with reference to FIG. 4. FIG. 4 is a diagram illustrating a configuration example of the information providing device 100 according to the embodiment. As illustrated in FIG. 4, the information providing device 100 includes a communication unit 110, a storage unit 120, and a control unit 130.

### Communication Unit 110

The communication unit 110 is implemented by, for example, a network interface card (NIC) or the like. Furthermore, the communication unit 110 is connected to the network N (see FIG. 2) in a wired or wireless manner.

### Storage Unit 120

The storage unit 120 is implemented by, for example, a semiconductor memory element such as a random access memory (RAM) or a flash memory, or a storage device such as a hard disk or an optical disk. As illustrated in FIG. 4, the storage unit 120 includes a user information database 121, a history information database 122, and a score information database 123.

### User Information Database 121

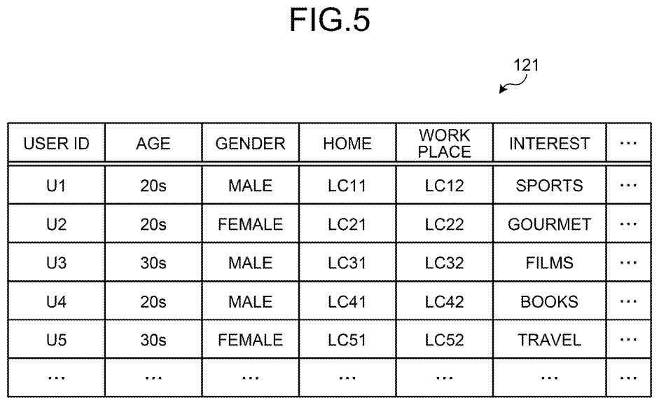

The user information database 121 stores user information on the user U. For example, the user information database 121 stores various types of information such as attributes of the user U. FIG. 5 is a diagram illustrating an example of the user information database 121. In the example illustrated in FIG. 5, the user information database 121 includes items such as “user identifier (ID)”, “age”, “gender”, “home”, “work place”, and “interest”.

The “user ID” indicates identification information for identifying the user U. Note that the “user ID” may be a contact address (telephone number, mail address, etc.) of the user U or identification information for identifying the terminal device 10 of the user U.

The “age” indicates the age of the user U identified by the user ID. Note that the “age” may be information indicating a specific age (for example, 35 years old) of the user U, or may be information indicating an age (for example, thirties) of the user U. Alternatively, the “age” may be information indicating the date of birth of the user U, or may be information indicating the generation of the user U (for example, born in the 80's). The “gender” indicates the gender of the user U identified by the user ID.

Furthermore, the “home” indicates position information on the home of the user U identified by the user ID. Note that, in the example illustrated in FIG. 5, the “home” illustrates an abstract code such as “LC11”, but may be latitude and longitude information or the like. Furthermore, for example, the “home” may be an area name or an address.

In addition, the “work place” indicates position information on the work place (school in the case of a student) of the user U identified by the user ID. Note that, in the example illustrated in FIG. 5, the “work place” is illustrated as an abstract code such as “LC12”, but may be latitude and longitude information or the like. Furthermore, for example, the “work place” may be an area name or an address.

Furthermore, the “interest” indicates an interest of the user U identified by the user ID. That is, the “interest” indicates a target of interest to the user U identified by the user ID. For example, the “interest” may be a search query (keyword) or the like searched by the user U inputting to a search engine. Note that, in the example illustrated in FIG. 5, one “interest” is illustrated for each user U, but a plurality of “interests” may be included.

For example, in the example illustrated in FIG. 5, the age of the user U identified by the user ID “U1” is “twenties”, and the gender is “male”. Furthermore, for example, the user U identified by the user ID “U1” indicates that the home is “LC11”. Furthermore, for example, the user U identified by the user ID “U1” indicates that the work place is “LC12”. Furthermore, for example, the user U identified by the user ID “U1” indicates that the user U is interested in “sports”.

Here, in the example illustrated in FIG. 5, it is illustrated using abstract values such as “U1”, “LC11”, and “LC12”, but it is assumed that information such as specific character strings and numerical values is stored for “U1”, “LC11”, and “LC12”. Hereinafter, abstract values may be illustrated in a diagram related to other information.

Note that the user information database 121 is not limited to the above, and may store various types of information depending on the purpose. For example, the user information database 121 may store various types of information regarding the terminal device 10 of the user U. In addition, the user information database 121 may store information regarding attributes of the user U, such as demographic attribute, psychographic attribute, geographic attribute, and behavioral attribute. For example, the user information database 121 may store information such as a name, a family structure, a hometown (local area), an occupation, a position, an income, a qualification, a residential form (detached house, apartment, etc.), presence or absence of a car, a school/commuting time, a school/commuting route, a commuter pass section (station, route, etc.), a frequently used station (other than the nearest station of the home/work place), a lesson (place, time zone, etc.), a hobby, an interest, a lifestyle, and the like.

### History Information Database 122

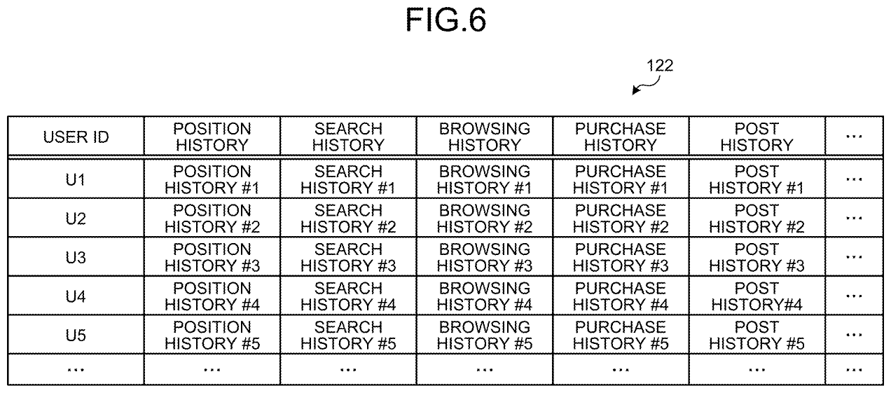

The history information database 122 stores various types of information related to history information (log data) indicating the behavior of the user U. FIG. 6 is a diagram illustrating an example of the history information database 122. In the example illustrated in FIG. 6, the history information database 122 includes items such as “user ID”, “position history”, “search history”, “browsing history”, “purchase history”, and “post history”.

The “user ID” indicates identification information for identifying the user U. The “position history” indicates a position history which is a history of the position and movement of the user U. The “search history” indicates a search history which is a history of search queries input by the user U. The “browsing history” indicates a browsing history which is a history of contents browsed by the user U. The “purchase history” indicates a purchase history which is a history of purchase of the user U. The “post history” indicates a post history which is a history of posts by the user U. Note that the “post history” may include a question regarding the possessions of the user U.

For example, in the example illustrated in FIG. 6, the user U identified by the user ID “U1” moves according to “position history #1”, searches according to “search history #1”, browses contents according to “browsing history #1”, purchases a predetermined product or the like at a predetermined store or the like according to “purchase history #1”, and posts according to “post history”.

Here, in the example illustrated in FIG. 6, it is illustrated using abstract values such as “U1”, “position history #1”, “search history #1”, “browsing history #1”, “purchase history #1”, and “post history #1”, but it is assumed that information such as specific character strings or numerical values is stored for “U1”, “position history #1”, “search history #1”, “browsing history #1”, “purchase history #1”, and “post history #1”.

Note that the history information database 122 is not limited to the above, and may store various types of information depending on the purpose. For example, the history information database 122 may store a use history or the like of a predetermined service of the user U. In addition, the history information database 122 may store a visit history of a real store of the user U, a visit history of a facility, or the like. Furthermore, the history information database 122 may store a payment history or the like of payment (electronic payment) using the terminal device 10 of the user U.

### Score Information Database 123

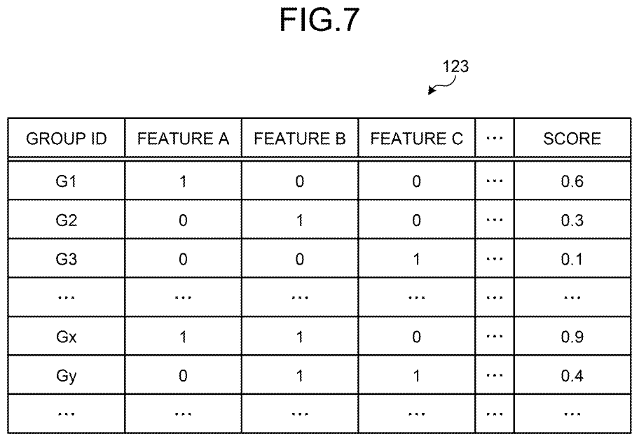

The score information database 123 stores various types of information regarding a score assigned to a user group having the same feature. FIG. 7 is a diagram illustrating an example of the score information database 123. In the example illustrated in FIG. 7, the score information database 123 includes items such as “group ID”, “feature”, and “score”.

The “group ID” indicates identification information for identifying a group of a user group having the same feature. That is, the “group ID” indicates identification information for identifying the user model. Furthermore, the “feature” indicates a feature possessed by users belonging to a group. For example, the “feature” indicates a user attribute or a user behavior. Furthermore, the “score” indicates a score calculated according to the feature possessed by the users belonging to the group.

For example, in the example illustrated in FIG. 7, it is indicated that a user belonging to a group identified by the group ID “G1” has “feature A” as a feature and the score is “0.6”.

Here, in the example illustrated in FIG. 7, it is illustrated using abstract values such as “G1”, “feature A”, “feature B”, and “feature C”, but it is assumed that information such as specific character strings and numerical values is stored for “G1”, “feature A”, “feature B”, and “feature C”.

Note that the score information database 123 is not limited to the above, and may store various types of information depending on the purpose. For example, the score information database 123 may store information regarding a model for calculating a score of a user group. In addition, the score information database 123 may store identification information for identifying individual users belonging to a group. Furthermore, the score information database 123 may store information regarding a client (for example, a client that permits provision of scores) to which the score is to be provided, identification information for identifying the information utilization device 200, and the like.

### Control Unit 130

Returning to FIG. 4, the description will be continued. The control unit 130 is a controller, and is implemented by, for example, a central processing unit (CPU), a micro processing unit (MPU), an application specific integrated circuit (ASIC), a field programmable gate array (FPGA), or the like executing various programs (corresponding to an example of an information processing program) stored in a storage device inside the information providing device 100 using a storage area such as a RAM as a work area. In the example illustrated in FIG. 4, the control unit 130 includes an acquisition unit 131, a generation unit 132, a reception unit 133, a calculation unit 134, and a providing unit 135.

### Acquisition Unit 131

The acquisition unit 131 collects data on an unspecified large number of users. At this time, the acquisition unit 131 acquires user information regarding the user U via the communication unit 110. For example, at the time of starting or operating a predetermined app, the acquisition unit 131 acquires identification information (user ID or the like) indicating the user U, position information on the user U, attribute information of the user U, and the like from the terminal device 10 of the user U. In addition, the acquisition unit 131 may acquire identification information indicating the user U, attribute information of the user U, and the like at the time of user registration of the user U. Then, the acquisition unit 131 registers the user information in the user information database 121 of the storage unit 120.

In addition, when the user U inputs a search query to a search engine or the like and performs keyword search, the acquisition unit 131 acquires the search query via the communication unit 110. In addition, the acquisition unit 131 acquires various types of history information (log data) indicating the behavior of the user U via the communication unit 110. For example, the acquisition unit 131 acquires various types of history information indicating the behavior of the user U from the terminal device 10 of the user U or from various servers or the like on the basis of the user ID or the like. Then, the acquisition unit 131 registers various types of history information in the history information database 122 of the storage unit 120.

### Generation Unit 132

The generation unit 132 generates a model for calculating a score of a user group satisfying a predetermined condition using collected data. For example, the generation unit 132 generates, as a predetermined condition, a model for calculating a score of a user group having performed a predetermined purchasing behavior. Alternatively, the generation unit 132 generates, as a predetermined condition, a model for calculating a score of a user group who have searched for a predetermined search query.

### Reception Unit 133

The reception unit 133 receives designation of a user condition from a business operator on the client side. For example, the reception unit 133 receives designation of a user condition from a business operator on the client side that independently generates a model and calculates a score of a user. Furthermore, the reception unit 133 receives designation of a user attribute, a user behavior, or a user ID as a user condition from a business operator.

### Calculation Unit 134

The calculation unit 134 calculates a score of a user group satisfying a user condition using a model. Furthermore, the calculation unit 134 further calculates at least one of a score average, a score upper layer, a percentile, and a weighted average on the basis of the calculated score.

### Providing Unit 135

The providing unit 135 provides information regarding the calculated score to the information utilization device 200, which is a server of a business operator on the client side. Furthermore, the providing unit 135 provides information indicating the relevance between the user condition and the predetermined condition to the information utilization device 200, which is a server of a business operator on the client side, on the basis of the calculated score. For example, the providing unit 135 provides information regarding the calculated score to the information utilization device 200, which is a server of a business operator on the client side, and complements the information regarding the score on the client side.

Note that the configuration of the information utilization device 200 according to the embodiment may be the same as that of the information providing device 100. For example, the information providing device 100 may have a function as the information utilization device 200.

### 5. Processing Procedure

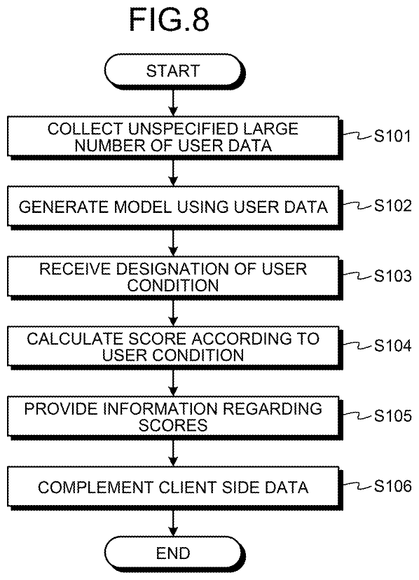

Next, a processing procedure by the information providing device 100 according to the embodiment will be described with reference to FIG. 8. FIG. 8 is a flowchart illustrating a processing procedure according to the embodiment. Note that the following processing procedure is repeatedly executed by the control unit 130 of the information providing device 100.

As illustrated in FIG. 8, the acquisition unit 131 of the information providing device 100 collects data on an unspecified large number of users (step S101).

Subsequently, the generation unit 132 of the information providing device 100 generates a model for calculating a score of a user group satisfying a predetermined condition using the collected data on an unspecified large number of users (step S102).

Subsequently, the reception unit 133 of the information providing device 100 receives designation of a user condition from the information utilization device 200, which is a server of a business operator on the client side that independently generates a model and calculates a score of a user (step S103).

Subsequently, the calculation unit 134 of the information providing device 100 calculates a score of a user group satisfying a designated user condition using the generated model (step S104).

Subsequently, the providing unit 135 of the information providing device 100 provides information regarding the calculated score to the information utilization device 200, which is a server of a business operator on the client side (step S105).

Subsequently, the information utilization device 200 complements the score of the user calculated by itself or information based on the score on the basis of the information regarding the score provided from the information providing device 100 (step S106).

### 6. Modification

The terminal device 10 and the information providing device 100 described above may be implemented in various different modes other than the above embodiment. Therefore, a modification of the embodiment will be described below.

In the above embodiment, a part or all of the processes executed by the information providing device 100 may be actually executed by the terminal device 10. In this case, it is assumed that the terminal device 10 has the function of the information providing device 100 in the above embodiment.

Furthermore, in the above-described embodiment, a part or all of the processes executed by the information utilization device 200 may be actually executed by the terminal device 10. In this case, it is assumed that the terminal device 10 has the function of the information utilization device 200 in the above embodiment.

Furthermore, in the above-described embodiment, the information providing device 100 may calculate the user attribute and the score according to the search query of the user by using a natural language processing method (distributed representation of words or the like) such as Word2vec.

### 7. Effects

As described above, the information processing device (information providing device 100) according to the present application includes: the acquisition unit 131 that collects data on an unspecified large number of users (users U); the generation unit 132 that generates a model for calculating a score of a user group satisfying a predetermined condition by using the collected data; the reception unit 133 that receives designation of a user condition from a business operator on the client side; the calculation unit 134 that calculates a score of a user group satisfying a user condition by using the model; and the providing unit 135 that provides the business operator with information regarding the calculated score.

Furthermore, the providing unit 135 provides the business operator with information indicating the relevance between the user condition and the predetermined condition on the basis of the calculated score.

For example, the generation unit 132 generates, as a predetermined condition, a model for calculating a score of a user group having performed a predetermined purchasing behavior.

Alternatively, the generation unit 132 generates, as a predetermined condition, a model for calculating a score of a user group who have searched for a predetermined search query.

Furthermore, the reception unit 133 receives designation of a user attribute as a user condition from the business operator.

Alternatively, the reception unit 133 receives designation of user behavior as a user condition from the business operator.

Alternatively, the reception unit 133 receives designation of a user ID as a user condition from the business operator.

Furthermore, the calculation unit 134 further calculates at least one of a score average, a score upper layer, a percentile, and a weighted average on the basis of the calculated score.

For example, the reception unit 133 receives designation of a user condition from a business operator on the client side that independently generates a model and calculates a score of a user. The providing unit 135 provides information regarding the calculated score to the business operator and complements the information regarding the score on the client side.

With any one or a combination of the above-described processing, the information processing device according to the present application can utilize information collected from users between companies. For example, the information collected from users by the client side company can be complemented using the information collected from users by the host side company without touching the personal information of the users.

### 8. Hardware Configuration

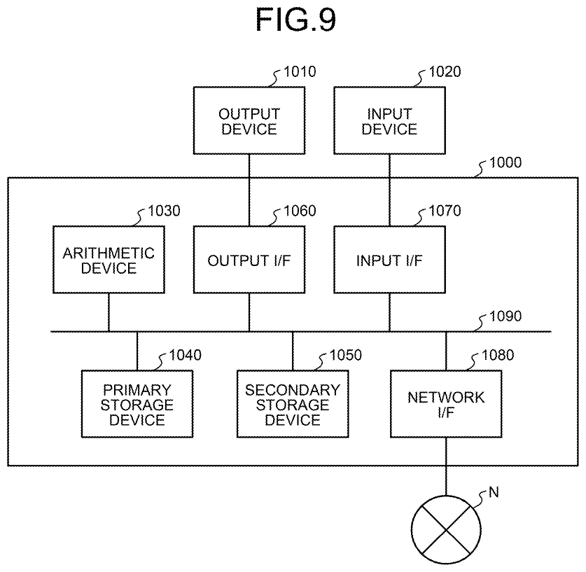

Furthermore, the terminal device 10 and the information providing device 100 according to the above-described embodiment are implemented by, for example, a computer 1000 having a configuration as illustrated in FIG. 9. Hereinafter, the information providing device 100 will be described as an example. FIG. 9 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (I/F) 1060, an input I/F 1070, and a network I/F 1080 are connected by a bus 1090.

The arithmetic device 1030 operates on the basis of a program stored in the primary storage device 1040 or the secondary storage device 1050, a program read from the input device 1020, or the like, and executes various kinds of processing. The arithmetic device 1030 is implemented by, for example, a central processing unit (CPU), a micro processing unit (MPU), an application specific integrated circuit (ASIC), a field programmable gate array (FPGA), or the like.

The primary storage device 1040 is a memory device such as a random access memory (RAM) that temporarily stores data used for various operations by the arithmetic device 1030. The secondary storage device 1050 is a storage device in which data used for various arithmetic operations by the arithmetic device 1030 and various types of databases are registered, and is implemented by a read only memory (ROM), a hard disk drive (HDD), a solid state drive (SSD), a flash memory, or the like. The secondary storage device 1050 may be a built-in storage or an external storage. Further, the secondary storage device 1050 may be a removable storage medium such as a universal serial bus (USE) memory or a secure digital (SD) memory card. The secondary storage device 1050 may be a cloud storage (online storage), a network attached storage (NAS), a file server, or the like.

The output I/F 1060 is an interface for transmitting information to be output to the output device 1010 that outputs various types of information such as a display, a projector, and a printer, and is implemented by, for example, a connector of a standard such as a universal serial bus (USB), a digital visual interface (DVI), or a high definition multimedia interface (HDMI) (registered trademark). Furthermore, the input I/F 1070 is an interface for receiving information from various input devices 1020 such as a mouse, a keyboard, a keypad, a button, a scanner, and the like, and is implemented by, for example, a USB or the like.

In addition, the output I/F 1060 and the input I/F 1070 may be wirelessly connected to the output device 1010 and the input device 1020, respectively. That is, the output device 1010 and the input device 1020 may be wireless devices.

Furthermore, the output device 1010 and the input device 1020 may be integrated like a touch panel. In this case, the output I/F 1060 and the input I/F 1070 may also be integrated as the input/output I/F.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like.

The network I/F 1080 receives data from another device via the network N and transmits the data to the arithmetic device 1030, and transmits data generated by the arithmetic device 1030 to another device via the network N.

The arithmetic device 1030 controls the output device 1010 and the input device 1020 via the output I/F 1060 and the input I/F 1070. For example, the arithmetic device 1030 loads a program from the input device 1020 or the secondary storage device 1050 onto the primary storage device 1040, and executes the loaded program.

For example, in a case where the computer 1000 functions as the information providing device 100, the arithmetic device 1030 of the computer 1000 implements the function of the control unit 130 by executing a program loaded on the primary storage device 1040. In addition, the arithmetic device 1030 of the computer 1000 may load a program acquired from another device via the network I/F 1080 onto the primary storage device 1040 and execute the loaded program. Furthermore, the arithmetic device 1030 of the computer 1000 may cooperate with another device via the network I/F 1080, and may call a function, data, and the like of the program from another program of another device to use.

### 9. Others

Although the embodiments of the present application have been described above, the present invention is not limited by the contents of these embodiments. In addition, the above-described constituent elements include those that can be easily assumed by those skilled in the art, those that are substantially the same, and those in a so-called equivalent range. Furthermore, the above-described components can be appropriately combined. Furthermore, various omissions, substitutions, or changes in the constituent elements can be made without departing from the gist of the above-described embodiments.

Of the various steps of processing described in the above embodiments, all or a part of the processing described as being performed automatically can be performed manually, or all or a part of the processing described as being performed manually can be performed automatically by a known method. In addition, the processing procedure, specific name, and information including various types of data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

For example, the above-described information providing device 100 may be implemented by a plurality of server computers, and depending on functions, the configuration can be flexibly changed such that an external platform or the like is called by an application programming interface (API), network computing, or the like to be implemented.

In addition, the above-described embodiments and modifications can be appropriately combined within a range that does not contradict processing contents.

In addition, the “part (section, module, unit)” described above can be read as “means”, “circuit”, or the like. For example, the acquisition unit can be replaced with an acquisition means or an acquisition circuit.

According to one aspect of the embodiments, there is an effect that it is possible to provide information matching the user's wish.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an acquisition unit that collects data on an unspecified large number of users;
a generation unit that generates a model for calculating a score of a user group satisfying a predetermined condition by using the data collected;
a reception unit that receives designation of a user condition from a business operator on a client side;
a calculation unit that calculates a score of a user group satisfying the user condition by using the model; and
a providing unit that provides information regarding the score calculated to the business operator.

2. The information processing device according to claim 1, wherein
the providing unit provides the business operator with information indicating relevance between the user condition and the predetermined condition based on the score calculated.

3. The information processing device according to claim 1, wherein
the generation unit generates a model for calculating a score of a user group having performed predetermined purchasing behavior as the predetermined condition.

4. The information processing device according to claim 1, wherein
the generation unit generates a model for calculating a score of a user group who have searched a predetermined search query as the predetermined condition.

5. The information processing device according to claim 1, wherein
the reception unit receives designation of a user attribute as the user condition from the business operator.

6. The information processing device according to claim 1, wherein
the reception unit receives designation of user behavior as the user condition from the business operator.

7. The information processing device according to claim 1, wherein
the reception unit receives designation of a user ID as the user condition from the business operator.

8. The information processing device according to claim 1, wherein
the calculation unit further calculates at least one of a score average, a score upper layer, a percentile, and a weighted average based on the score calculated.

9. The information processing device according to claim 1, wherein
the reception unit receives the designation of the user condition from the business operator on the client side that independently generates a model and calculates a score of a user, and
the providing unit provides the information regarding the score calculated to the business operator and complements information regarding the score on the client side.

10. An information processing method performed by an information processing device, the information processing method comprising:
an acquisition step of collecting data on an unspecified large number of users;
a generation step of generating a model for calculating a score of a user group satisfying a predetermined condition by using the data collected;
a reception step of receiving designation of a user condition from a business operator on a client side;
a calculation step of calculating a score of a user group satisfying the user condition by using the model; and
a providing step of providing information regarding the score calculated to the business operator.

11. A non-transitory computer readable storage medium storing an information processing program for causing a computer to execute:
an acquisition procedure of collecting data on an unspecified large number of users;
a generation procedure of generating a model for calculating a score of a user group satisfying a predetermined condition by using the data collected;
a reception procedure of receiving designation of a user condition from a business operator on a client side;
a calculation procedure of calculating a score of a user group satisfying the user condition by using the model; and
a provision procedure of providing information regarding the score calculated to the business operator.
